(19) United States
(12) Patent Application Publication
(10) Pub. No.: US 2012/0124342 A1
(43) Pub. Date: May 17, 2012

(54) CONCURRENT CORE AFFINITY FOR WEAK COOPERATIVE MULTITHREADING SYSTEMS

(75) Inventors: Moshe M.E. Matsa, Cambridge, MA (US); Eric D. Perkins, Boston, MA (US)

(73) Assignee: INTERNATIONAL BUSINESS MACHINES CORPORATION, Armonk, NY (US)

(21) Appl. No.: 12/945,689

(22) Filed: Nov. 12, 2010

(51) Int. Cl. G06F 9/318

(52) U.S. Cl. 712/226; 712/E09.035

(57) ABSTRACT

A data structure is stored. Further, a plurality of operations performed on the data structure is modified to be per core instead of per thread so that a subset of the plurality of threads safely share the data structure. In addition, interruption of each of the plurality of threads in the subset is prevented unless one or more of each of the plurality of threads in the subset allows the interruption.

### BACKGROUND

1. Field

This disclosure generally relates to a computing environment. More particularly, the disclosure relates to multithreading systems.

2. General Background

In general, many concurrent data structures in a multithreaded system can perform work and store data for each thread. Such performance and storage is called per thread. For example, sets, stacks, etc. may be stored per thread. Performance is typically improved when the interaction between threads is reduced. If each thread stays on the same core, then all of the data for each thread also stays in the same level-1 cache. When threads get scheduled on different cores, then all of the corresponding data for the threads has to be migrated between level-1 and/or level-2 caches. As a result, the performance is affected with a slowdown.

### SUMMARY

Method, system and computer program product embodiments of the invention are provided for multi-threading by storing a data structure, modifying a plurality of operations performed on the data structure to be per core instead of per thread so that a subset of the plurality of threads safely share the data structure, and preventing interruption of each of the plurality of threads in the subset unless one or more of each of the plurality of threads in the subset allows the interruption.

### DRAWINGS

The above-mentioned features of the present invention will become more apparent with reference to the following description taken in conjunction with the accompanying drawings wherein like reference numerals denote like elements and in which:

FIG. 1 illustrates a cooperative multithreaded system according an embodiment of the present invention.

FIG. 2 illustrates a non-cooperative preemptive system according to an embodiment of the present invention.

FIG. 3 illustrates a non-cooperative preemptive system according to an embodiment of the present invention that is an alternative to the non-cooperative preemptive system illustrated in FIG. 2.

FIG. 4 illustrates a process that performs per core modification according to an embodiment of the present invention.

FIG. 5 illustrates a process that performs per core modification according to another embodiment of the present invention.

FIG. 6 illustrates a process that performs per core modification according to yet another embodiment of the present invention.

FIG. 7 illustrates a block diagram of a system that performs per core modification according to an embodiment of the present invention.

### DETAILED DESCRIPTION

In a cooperative multithreaded environment, each thread will not be interrupted except when the thread allows itself to yield. According to an embodiment of the present invention, the code for the data structure may be written so that the data structure will not yield in the middle of performing one of the operations when the data structure needs a measure of atomicity between the operations. As a result, all threads on a given core may safely share a single sub-data-structure. According to another embodiment of the present invention, the code may be written for weak cooperative preemptive multithreaded systems within the key subset of threads. In one embodiment, at least one of the objects may have an add operation that is performed on a different thread than the remove operation.

Further, the data structure may be initialized with one sub-data-structure per core on the machine, which may at least be utilized for the key subset of threads. The term core is intended to mean a component of a processor that performs reading and/or executing of instructions. Multiple cores may be stored each on separate processors, all on one processor, or a combination thereof. The one memory page with the mapping from core number to sub-data-structure is not modified and will thus reside in all level-1 caches. Accordingly, the one memory page with the mapping will never need to be written or re-retrieved. The memory with each sub-data-structure will only reside in the level-1 cache for that core.

If there are any other threads, the resulting performance is enhanced because of the elimination of cache coherency traffic for this data structure. Further, for all threads in the key subset of threads, the common case should never need to go beyond the level-1 cache. The resulting performance is better than per thread storage or any wait-free or lock-free synchronization system utilizing main memory primitives such as CAS instructions, or locking solutions.

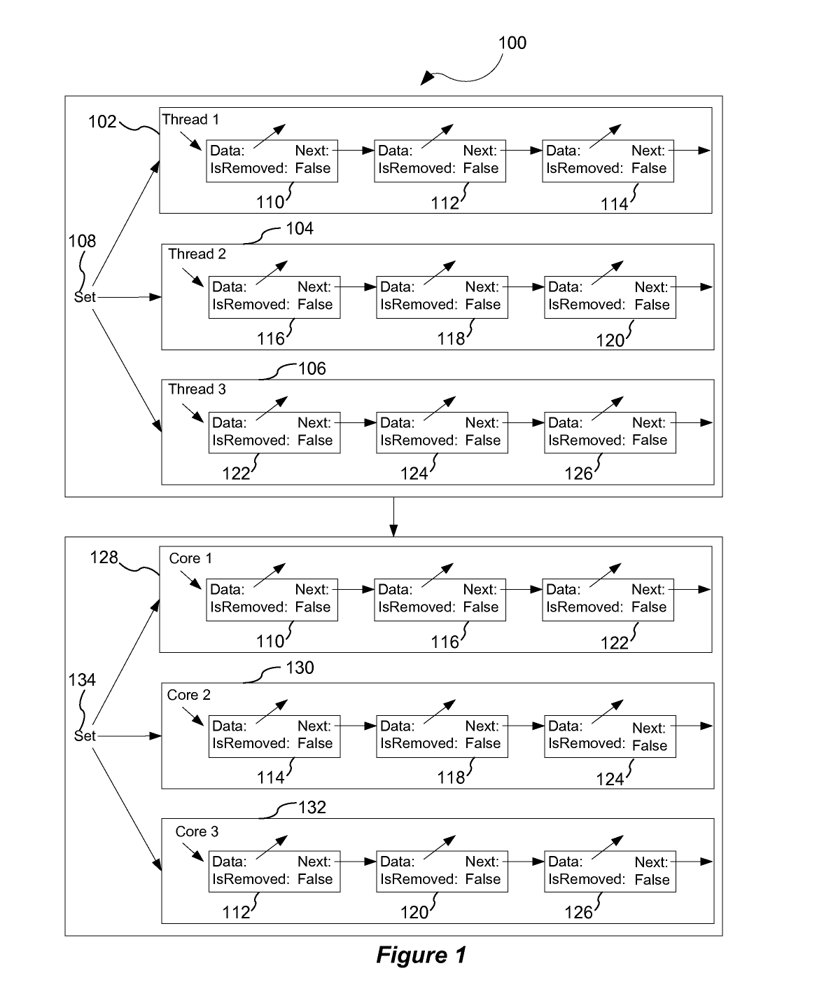

FIG. 1 illustrates a cooperative multithreaded system 100 according to an embodiment of the present invention. The relevant concurrent data structure is implemented to ensure that it will never yield in the middle of operations that need to be atomic relative the data for the operations. The operations are further modified to act per core instead of per thread. The term per thread includes both a single data structure with memory per thread and a small data structure per thread in each thread's local storage.

The cooperative multithreaded system 100 involves a common case of the core accessing its own level-1 cache. Regardless of where threads are scheduled, the relevant data for the data structures is always on the same core. Further, when a thread, for example, retrieves an element from a data structure on the core that added the element, that data is also likely to be in the same level-1 cache and thus even more cache-coherency traffic is saved.

The cooperative multithreaded system 100 modifies the data structure by utilizing the subsets from a set 108. The storage is modified from a per thread storage system to a per core storage system. As an example, the set 108 has one or more elements that are stored by a first thread 102, a second thread 104, and a third thread 106. The first thread 102 stores a first element 110, a second element 112, and a third element 114. Further, the second thread 104 stores a first element 116, a second element 118, and a third element 120. In addition, the third thread 106 stores a first element 122, a second element 124, and a third element 126. The cooperative multithreaded system 100 performs a modification so that a set 134 has one or more elements that are stored by a first core 128, a second core 130, and a third core 132. The first element 110, the first element 116, and the first element 122 are stored on the first core 128. The third element 114, the second element 118, and the second element 124 are stored on the second core 130. In addition, the second element 112, the third element 120, and the third element 126 are stored on the third core 132.

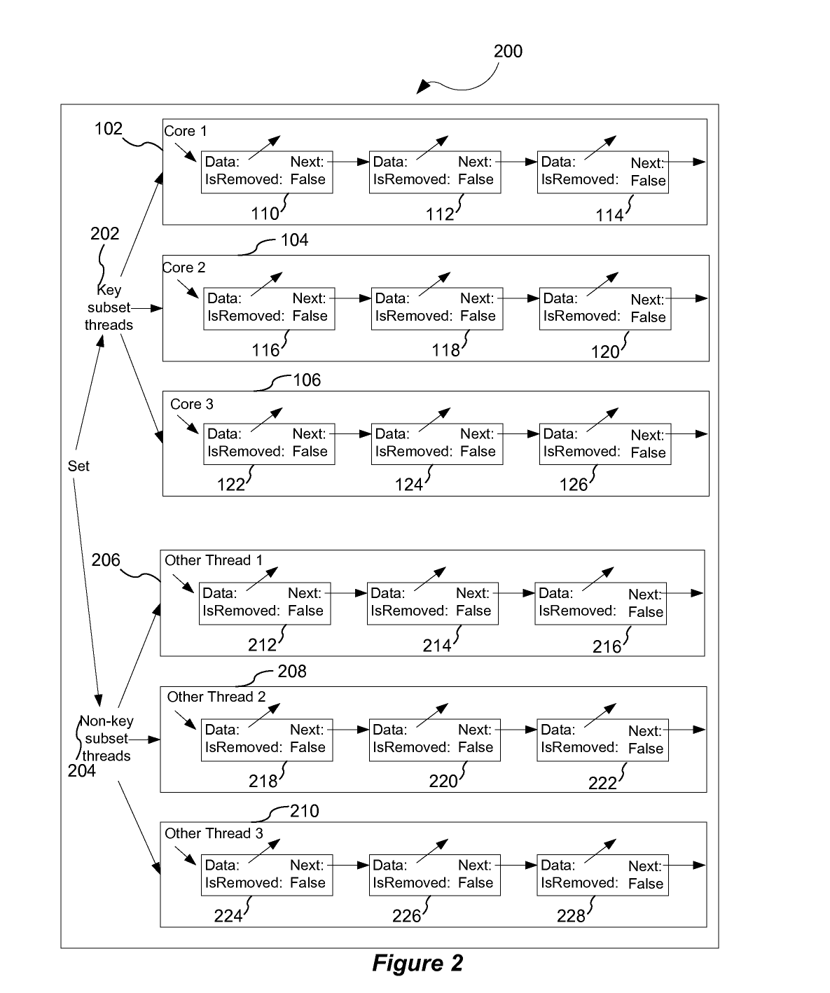

A modification from a per thread storage system to a per core storage system may also be utilized with a non-cooperative preemptive system. FIG. 2 illustrates a non-cooperative preemptive system 200 according to an embodiment of the present invention. Within the non-cooperative preemptive system 200, some programs control some subset of their threads enough so that they can guarantee that each of these threads, if preempted, will be rescheduled again on the same core prior to any other threads of the subset being scheduled on the core. The programs can keep one sub-data-structure per core which is shared by all threads in this special subset. In one embodiment, one additional sub-data-structure per thread for the other threads is provided. For programs where the key work is performed by worker threads which are more tightly controlled, these guarantees may be met and performance may be enhanced.

The per thread structure is converted such that the resulting configuration illustrated in FIG. 2 has one or more key subset threads 202 and one or more non-key subset threads 204. The one or more key subset threads 202 are modified to be stored per core whereas the one or more non-key subset threads 204 are stored with a per thread structure. For the example a first other thread 206 may store a first non-key element 212, a second non-key element 214, and a third non-key element 216. Further, a second other thread 208 may store a second other thread 208 may store a first non-key element 218, a second non-key element 220, and a third non-key element 222. In addition, a third other thread may store a first non-key element 224, a second non-key element 226, and a third non-key element 228.

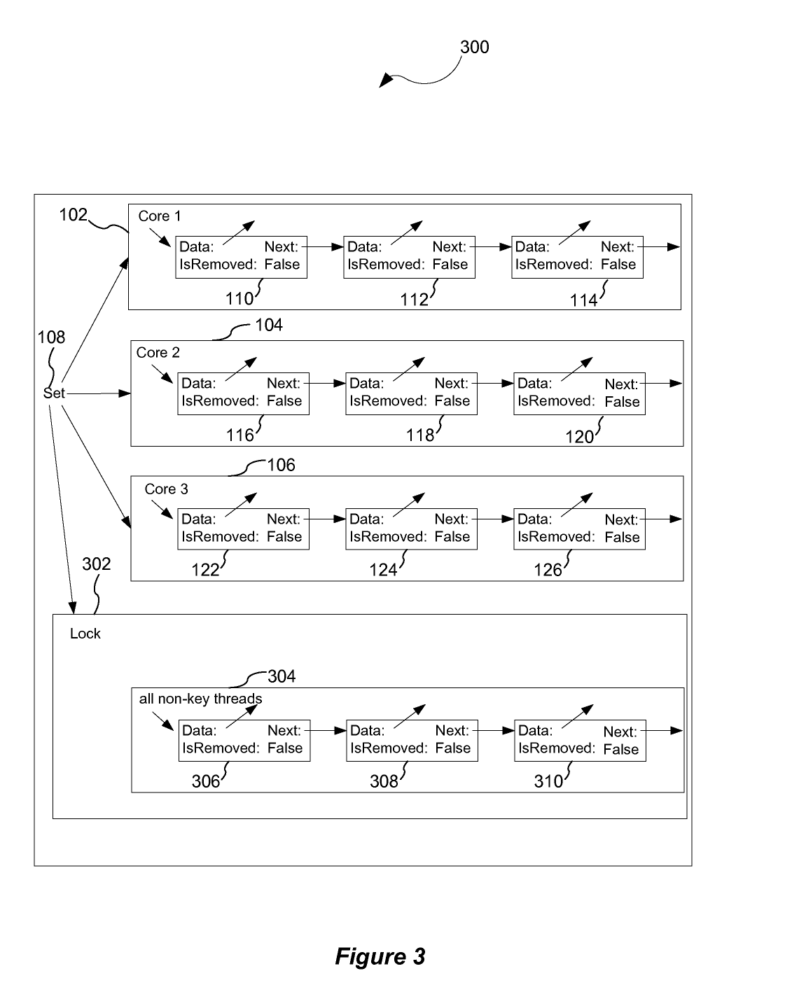

FIG. 3 illustrates a non-cooperative preemptive system 300 according to an embodiment of the present invention that is an alternative to the non-cooperative preemptive system illustrated in FIG. 2. A lock 302 guards a set 304 of all non-key threads whereas the key threads are modified to be stored per core. The non-key threads may be stored in a first non-key element 306, a second non-key element 308, and a third non-key element 310.

The quantities illustrated in FIGS. 1-3 are provided merely for illustrative purposes. Various quantities of sets, subsets, etc. may be utilized with the configurations described herein.

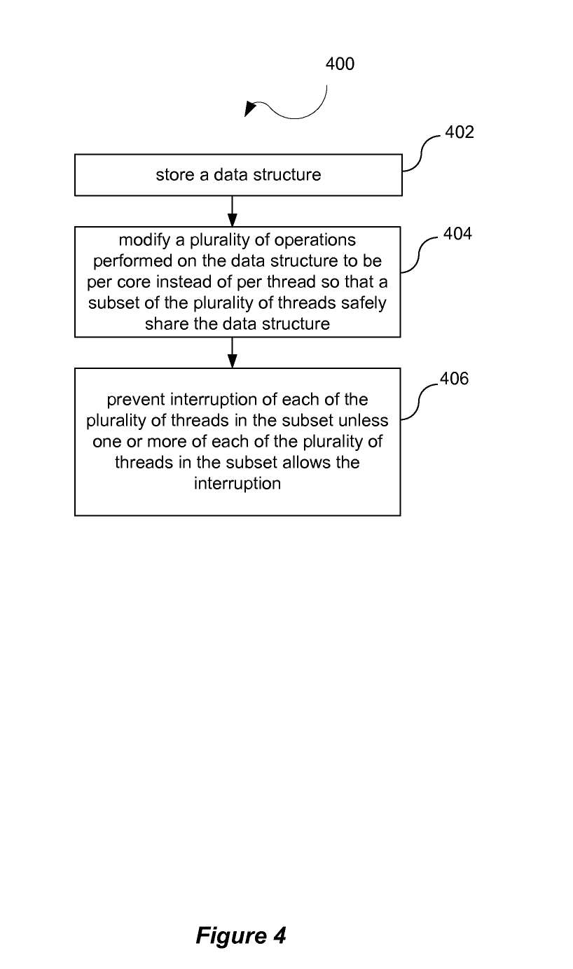

FIG. 4 illustrates a process 400 that performs per core modification according to an embodiment of the present invention. At a process block 402, the process 400 stores a data structure. Further, at a process block 404, the process modifies a plurality of operations performed on the data structure to be per core instead of per thread so that a subset of the plurality of threads safely share the data structure. In addition, at a process block 406, the process 400 prevents interruption of each of the plurality of threads in the subset unless one or more of each of the plurality of threads in the subset allows the interruption. A processor in a computing device may be utilized to perform the storage, modification, and/or prevention.

In one embodiment, a registration application programming interface (“API”) that the data structure calls to return a token upon registering sensitive data is provided. Further, an entry API that each of the plurality of operations calls with the token upon entering a sensitive data region after which a thread prevents interruption may be provided. In addition, a thread identifier and/or a core identifier of a thread in the sensitive data region may be recorded. The thread trying to enter into the sensitive data region on the core may be swapped out while any older thread already in the sensitive data region on the core may be swapped in.

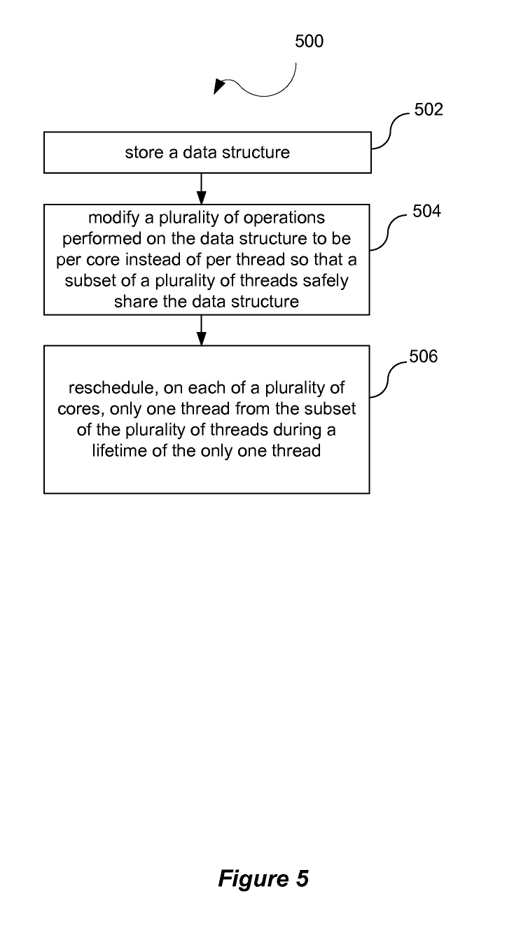

FIG. 5 illustrates a process 500 that performs per core modification according to another embodiment of the present invention. At a process block 502, the process 500 stores a data structure. Further, at a process block 504, the process 500 modifies a plurality of operations performed on the data structure to be per core instead of per thread so that a subset of the plurality of threads safely share the data structure. In addition, at a process block 506, the process 500 reschedules, on each of a plurality of cores, only one thread from the subset of the plurality of threads during a lifetime of the only one thread. A processor in a computing device may be utilized to perform the storage, modification, and/or rescheduling. In one embodiment, all threads in the subset may be terminated if a thread in the subset has claimed the core for a time period that exceeds a threshold

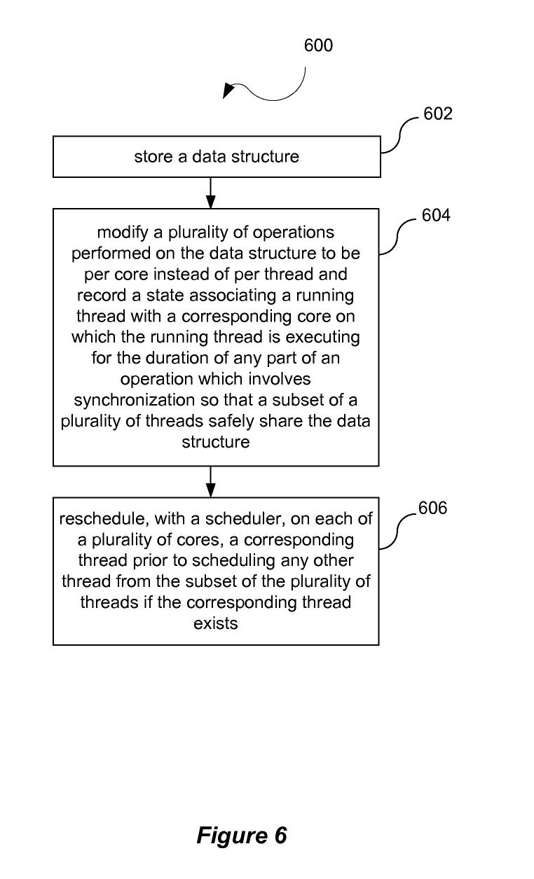

FIG. 6 illustrates a process 600 that performs per core modification according to yet another embodiment of the present invention. At a process block 602, the process 600 stores a data structure. Further, at a process block 604, the process 600 modifies a plurality of operations performed on the data structure to be per core instead of per thread and record a state associating a running thread with a corresponding core on which the running thread is executing for the duration of any part of an operation which involves synchronization so that a subset of a plurality of threads safely share the data structure. In addition, at a process block 606, the process 600 reschedules, with a scheduler, on each of a plurality of cores, a corresponding thread prior to scheduling any other thread from the subset of the plurality of threads if the corresponding thread exists. A processor in a computing device may be utilized to perform the storage, modification, and/or rescheduling.

In one embodiment, the state associating the running thread with the corresponding core is a flag that provides an indication to the scheduler that a data sensitive operation is occurring. In an alternative embodiment, the state associating the running thread with the corresponding core is a thread identifier stored in per-core storage in the data structure. In yet another embodiment, the state associating the running thread with the corresponding core is a core identifier stored in a scheduler known location in a per-thread data structure. In one embodiment, all threads in the subset may be terminated if a thread in the subset has claimed the core for a time period that exceeds a threshold

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool.

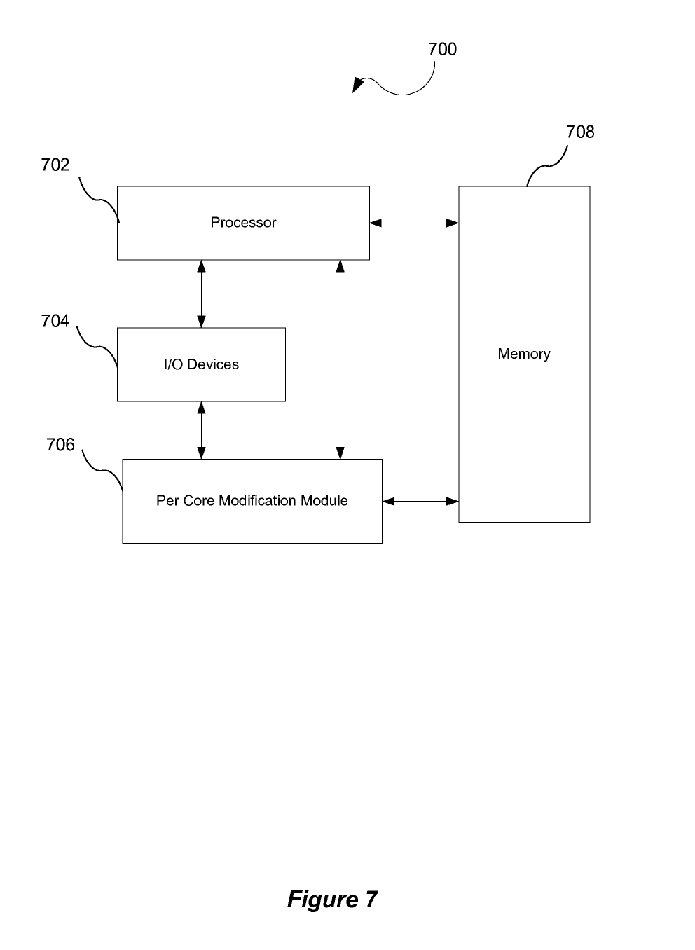

FIG. 7 illustrates a block diagram of a system 700 that performs per core modification according to an embodiment of the present invention. In one embodiment, the system 700 is suitable for storing and/or executing program code and is implemented using a general purpose computer or any other hardware equivalents. Thus, the system 700 comprises a processor 702, a memory 708, e.g., random access memory (“RAM”) and/or read only memory (“ROM”), a per core modification module 706, and various input/output devices 704.

The processor 702 is coupled, either directly or indirectly, to the memory 708 through a system bus. The memory 708 may include local memory employed during actual execution of the program code, bulk storage, and/or cache memories which provide temporary storage of at least some program code in order to reduce the number of times code must be retrieved from bulk storage during execution.

The input/output devices 704 may be coupled directly to the system 700 or through intervening input/output controllers. Further, the input/output devices 704 may include a keyboard, a keypad, a mouse, a microphone for capturing speech commands, a pointing device, and other user input devices that will be recognized by one of ordinary skill in the art. Further, the input/output devices 704 may include a receiver, transmitter, speaker, display, image capture sensor, biometric sensor, etc. In addition, the input/output devices 704 may include storage devices such as a tape drive, floppy drive, hard disk drive, compact disk (“CD”) drive, digital video disk (“DVD”) drive, etc.

Network adapters may also be coupled to the system 700 to enable the system 700 to become coupled to other systems, remote printers, or storage devices through intervening private or public networks. Modems, cable modems, and Ethernet cards are just a few of the currently available types of network adapters.

For any of the configurations described herein, various actions may take place when the call stack is retrieved. In one embodiment, the retrieved call stack is walked into a tree and the leaf node of the tree has its base count incremented, which allows for utilization of technology to produce reports or to view the collected information.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The “processor” of a general purpose computer, special purpose computer, or other programmable data processing apparatus may be referred to herein as a “microprocessor.” However, the term “microprocessor” should not be interpreted as being limited to a single-chip central processing unit or any other particular type of programmable data processing apparatus, unless explicitly so stated.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Reference throughout this Specification to “one embodiment,” “an embodiment,” or similar language means that a particular feature, structure, or characteristic described in connection with the embodiment is included in at least one embodiment of the present invention. Thus, appearances of the phrase “in one embodiment,” “in an embodiment,” and similar language throughout this Specification may, but do not necessarily, all refer to the same embodiment. Furthermore, the described features, structures, or characteristics of the invention may be combined in any suitable manner in one or more embodiments. Correspondingly, even if features are initially claimed as acting in certain combinations, one or more features from a claimed combination may in some cases be excised from the combination, and the claimed combination may be directed to a subcombination or variation of a subcombination.

While the computer program product, method and system have been described in terms of what are presently considered to be the most practical and preferred embodiments, it is to be understood that the disclosure need not be limited to the disclosed embodiments. The disclosure is intended to cover various modifications and similar arrangements included within the spirit and scope of the claims, the scope of which should be accorded the broadest interpretation so as to encompass all such modifications and similar structures. The present disclosure includes any and all embodiments of the following claims.

We claim:

1. A computer program product for multi-threading, the computer program product comprising:
a computer readable storage medium having computer readable program code embodied therewith, the computer readable program code comprising:
computer readable program code configured to store a data structure;
computer readable program code configured to modify a plurality of operations performed on the data structure to be per core instead of per thread so that a subset of the plurality of threads safely share the data structure; and
computer program code configured to prevent interruption of each of the plurality of threads in the subset unless one or more of each of the plurality of threads in the subset allows the interruption.

2. The computer program product of claim 1, further comprising computer program code configured to provide a registration application programming interface that the data structure calls to return a token upon registering sensitive data.

3. The computer program product of claim 2, further comprising computer program code configured to provide an entry application programming interface that each of the plurality of operations calls with the token upon entering a sensitive data region after which a thread prevents interruption.

4. The computer program product of claim 3, further comprising computer program code configured to record a thread identifier and a core identifier of a thread in the sensitive data region.

5. The computer program product of claim 4, further comprising computer program code configured to swap out the thread trying to enter into the sensitive data region on the core and swap in any older thread already in the sensitive data region on the core.

6. The computer program product of claim 1, further comprising computer program code configured to reschedule, on each of a plurality of cores, only one thread from the subset of the plurality of threads during a lifetime of the only one thread.

7. The computer program product of claim 1, further comprising computer program code configured to record a state associating a running thread with a corresponding core on which the running thread is executing for the duration of any part of an operation which involves synchronization so that a subset of a plurality of threads safely share the data structure and reschedule, with a scheduler, on each of a plurality of cores, a corresponding thread prior to scheduling any other thread from the subset of the plurality of threads if the corresponding thread exists.

8. A method comprising:
storing a data structure;
modifying a plurality of operations performed on the data structure to be per core instead of per thread so that a subset of the plurality of threads safely share the data structure; and
preventing interruption of each of the plurality of threads in the subset unless one or more of each of the plurality of threads in the subset allows the interruption.

9. The method of claim 8, further comprising providing a registration application programming interface that the data structure calls to return a token upon registering sensitive data.

10. The method of claim 9, further comprising providing an entry application programming interface that each of the plurality of operations calls with the token upon entering a sensitive data region after which a thread prevents interruption.

11. The method of claim 10, further comprising recording a thread identifier and a core identifier of a thread in the sensitive data region.

12. The method of claim 11, further comprising swapping out the thread trying to enter into the sensitive data region on the core and swap in any older thread already in the sensitive data region on the core.

13. The method of claim 9, further comprising rescheduling, on each of a plurality of cores, only one thread from the subset of the plurality of threads during a lifetime of the only one thread.

14. The method of claim 9, further comprising recording a state associating a running thread with a corresponding core on which the running thread is executing for the duration of any part of an operation which involves synchronization so that a subset of a plurality of threads safely share the data structure and reschedule, with a scheduler, on each of a plurality of cores, a corresponding thread prior to scheduling any other thread from the subset of the plurality of threads if the corresponding thread exists.

15. A system comprising:
a storage module that stores a data structure;
a modification module that modifies a plurality of operations performed on the data structure to be per core instead of per thread so that a subset of the plurality of threads safely share the data structure; and
a prevention module that prevents interruption of each of the plurality of threads in the subset unless one or more of each of the plurality of threads in the subset allows the interruption.

16. The system of claim 15, further comprising a registration application programming interface that the data structure calls to return a token upon registering sensitive data.

17. The system of claim 16, further comprising an entry application programming interface that each of the plurality of operations calls with the token upon entering a sensitive data region after which a thread prevents interruption.

18. The system of claim 17, further comprising a recordation module that records a thread identifier and a core identifier of a thread in the sensitive data region.

19. The system of claim 18, further comprising a swap module that swaps out the thread trying to enter into the sensitive data region on the core and swap in any older thread already in the sensitive data region on the core.

20. The system of claim 15, further comprising a rescheduler module that reschedules, on each of a plurality of cores, only one thread from the subset of the plurality of threads during a lifetime of the only one thread.
